(19) United States
(12) Patent Application Publication
(10) Pub. No.: US 2025/0053952 A1
(43) Pub. Date: Feb. 13, 2025

(54) DYNAMIC CUSTOMIZED INCENTIVES FOR INSTALLMENT PAYMENT PLANS

(71) Applicant: MASTERCARD INTERNATIONAL INCORPORATED, PURCHASE, NY (US)

(72) Inventors: Rakshith Gabri, Chitradurga (IN); Ravi Matanhelia, Bahraich (IN); Sayali Moharil, Pune (IN); Deepak Ganesh Paradesi, Pune (IN)

(21) Appl. No.: 18/448,105

(22) Filed: Aug. 10, 2023

(51) Int. Cl. G06Q 20/22; G06Q 20/12; G06Q 20/24; G06Q 30/0207

(52) U.S. Cl. CPC G06Q 20/29; G06Q 20/12; G06Q 20/24; G06Q 30/0239

(57) ABSTRACT

Examples provide dynamic incentives for installment payment plans. A request for a dynamic incentive associated with an installment payment plan is received. An incentives manager analyzes transaction data, associated with a transaction performed on a merchant application or a website, using a set of user-configured rules to generate dynamic incentives in real-time. The incentives are customized for each user such that two users presented with the same installment payment plan are offered different incentives based on their previous transaction history, merchant preferences, dynamic market trends data, and/or payment card data. The incentives can be prioritized using scores and/or rankings enabling the system to present the highest priority incentives to the user. The customized incentives are presented to the user with the installment payment plans in real-time during completion of the transaction. By offering incentives to the user, user stay on the merchant application or the website is extended.

### BACKGROUND

When users wish to purchase items, e.g., from a merchant application or website, they can opt to pay for an item in full or in part at a later date rather than paying the full purchase price at the time of purchase. In such cases, the user is offered a payment plan by the merchant, or a lender that includes one or more installment payments which are paid by the user at one or more future dates. Breaking up payment for a large ticket item into smaller payments can lessen the immediate financial burden of making a single large payment. However, in many cases, users are not motivated to avail themselves of installment payment plan options, especially where the offered plans include a fee or other costs. This can be problematic, as many users that might otherwise purchase items on a payment plan reject lender payment plan offers resulting in underutilization of available payment plans. This leads to both inconvenience for customers, as well as lenders. Further, because lenders and merchants are limited to providing generic installment payment plans, which may be unsuitable or undesirable to the user, many users may precipitously leave or exit the merchant application or website without completing the desired purchase, which reduces the number of users accessing the merchant application or website. Thus, there is a need for a technical solution that can extend user stay on the merchant application or website while increasing the suitability and acceptability of offered installment payment plans to customers.

### SUMMARY

Some examples provide a system for dynamic and customized installment payment plan incentives. The system includes at least one processor and at least one memory including computer-readable instructions. An incentives manager receives a request for a dynamic incentive associated with an installment payment plan customized for a user during a transaction. The incentives manager applies a set of user-configurable rules to transaction data associated with the user and the transaction. The set of user-configurable rules includes criteria for generating the dynamic incentive. The incentives manager generates the dynamic incentive associated with the installment payment plan based on application of the set of user-configured rules to the transaction data. The incentives manager presents an offer to the user via a user interface device comprising the installment payment plan and the generated dynamic incentive customized for the user in real-time during the transaction to incentivize customer acceptance of available installment plans.

Other examples provide a method for generating dynamic incentives for installment payment plans. An incentives manager receives a request for an installment payment plan incentive customized for a user in real-time from a requester via a network. The request associated with a transaction to purchase an item or service from a merchant. The incentives manager applies a set of user-configured rules to transaction data associated with the user and the transaction. The set of user-configured rules includes a set of user-configured incentives criteria associated with the merchant or a lender. The incentives manager generates dynamic incentives associated with the installment payment plan based on application of the set of user-configured rules to the transaction data. A score is calculated for each dynamic incentive indicating a priority associated with the dynamic incentive. A dynamic incentive associated with a highest score is selected for presentation to the user. The selected dynamic incentive is transmitted to the requester for presentation to the user via a user interface device. The dynamic incentive is customized for the user in real-time during the transaction.

Still other examples provide a computer storage media having computer-executable instructions. An incentives manager obtains a request for a dynamic incentive for an installment payment plan customized for a user in real-time during a transaction. The request includes payment card data associated with a payment card presented by the user. The incentives manager analyzes transaction data for the transaction using a set of user-configured rules. The set of user-configured rules including one or more merchant preferences and a payment card category associated with the payment card presented by the user. The transaction data includes dynamic market trends data and/or user transaction history data. The incentives manager generates a dynamic incentive associated with the installment payment plan based on application of the set of user-configured rules to the transaction data. An offer is presented to the user via a user interface device for acceptance or rejection, the offer comprising the installment payment plan and the dynamic incentive customized for the user, thereby increasing utilization of merchant application and websites while also improving offer acceptance rates by users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for providing dynamic installment payment plan incentives.

FIG. 2 is an exemplary block diagram illustrating a system for generating per-installment payment plan dynamic incentives customized for each user.

FIG. 3 is an exemplary block diagram illustrating an incentives manager for generating dynamic incentives for installment payment plans.

FIG. 4 is an exemplary data flow illustrating a process for onboarding a new customer into the dynamic incentives services system.

FIG. 5 is an exemplary data flow illustrating a process for installment payment process set up with dynamic incentives.

FIG. 6 is an exemplary data flow illustrating a process for installment payment plans with dynamic incentives presentment.

FIG. 7 is an exemplary data flow illustrating a process for checkout by selecting installments with dynamic incentives offers.

FIG. 8 is an exemplary data flow illustrating a process for merchant-initiated rewards processing.

FIG. 9 is an exemplary process flow illustrating dynamic incentives setup.

FIG. 10 is an exemplary process flow illustrating dynamic incentives generation by an installment service.

FIG. 11 is an exemplary process flow illustrating dynamic incentives generation customized for a user based on a user payment card.

FIG. 12 is an exemplary flow chart illustrating operation of the computing device to provide dynamic installment payment plan incentives customized for a user.

FIG. 13 is an exemplary flow chart illustrating operation of the computing device to present a user with dynamic incentives predicted to be of greatest interest to the user.

FIG. 14 is an exemplary flow illustrating operation of the computing device to generate a customized installment payment plan incentive for each user.

FIG. 15 is an exemplary screenshot including user interface (UI) presenting an installment payment plan option to a user during a transaction.

FIG. 16 is an exemplary screenshot including UI presenting installment payment plan options with dynamic incentives customized for the user.

FIG. 17 illustrates a computing apparatus according to an embodiment as a functional block diagram.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Merchants and lenders frequently have various payment plan options available which can be utilized by consumers interested in making a large purchase. Installment payment plans can increase consumer purchasing power while also improving traffic to merchant websites. Merchants and/or lenders may offer all consumers the same incentives to increase acceptance of installment plans, however, consumers frequently reject offers due to a lack of interest in generic incentives, which may be of little or no value to the user. For example, an offer of frequent flier benefits may be useless to a person that rarely travels.

It is frequently difficult or impossible for merchants and/or lenders to customize offers and/or incentives to specific consumers due to a lack of information associated with each consumer's interests, hobbies, habits, and other personal preferences. Moreover, requesting this information from each consumer at the time of purchase would be unfeasible due to the time and inconvenience to the consumer attempting to complete a purchase transaction in a timely manner. Therefore, it is very difficult for lenders and/or merchants to anticipate which payment plan terms and incentives which are most likely to be accepted by a specific user. This results in the problems of underutilization of available installment payment plans and decreased customer satisfaction with offered plans and generic incentives.

Referring to the figures, examples of the disclosure enable dynamic creation of customized incentives for installment payment plans. In some examples, an incentives manager applies user-configurable rules to transaction data associated with a transaction aggregated from a plurality of sources. This aggregated data is used to identify dynamic incentives customized for the user. The dynamic incentives are customized to each consumer to encourage more consumers to utilize available installment payment options while also improving customer experience and satisfaction with the offered payment plans.

In other examples, the system aggregates data associated with users interests and preferences to identify incentives which are most likely to be valued and desirable to the user. The data is aggregated from sources which might otherwise be unavailable to merchants and/or lenders and analyzed using machine learning trained to identify user-specific incentives most likely to be accepted by each user. This solves the problem of providing real-time customization of offers and/or incentives without inconveniencing the user by requiring the user to answer questions or review generic offers unlikely to be valued by the user.

In other examples, a different dynamic incentive is selected for each installment payment plan and/or each different user. This enables provision of incentives to customize each user which are calculated to be of the greatest value or utility to each user in real-time as the user is performing a purchase transaction with minimal inconvenience to the consumer.

In still other examples, customized installment payment plan incentives are presented to users via a user interface of a computing device in real-time as the user is engaged in completing a transaction for purchase of goods and/or services automatically without user intervention enabling improved user efficiency via the UI interaction.

The system, in other examples, provides a rewards platform that provides offers, including cashback rewards and other incentives with buy now pay later (BNPL) installment payment plans presented on merchant checkout. The incentives enable merchants to increase sales by providing customized installment payment options with lucrative cashback and other incentives for customers. For example, if the user is offered suitable customized installment payment options, the user stay on the merchant application, website, or store is extended in comparison to when the user is not offered a customized installment payment option. Ways of extending user stay on the merchant application, website, or store provide a technical solution to the problem faced by the developers of merchant applications or websites who want to retain users as well as want repeat user visits to the merchant application or website. The issuers and lenders utilize the customized incentives to attract new customers as well as retain existing customers, thereby increasing adoption and acquisition of installment payment plans. Customers (cardholders) are further provided with greater availability of lucrative cashback and other rewards when competing payment transactions using installments.

The conventional computing device operates in an unconventional manner by analyzing per-user and per-transaction data with user-configurable rules in real-time to dynamically provide customized incentives capable of maximizing customer satisfaction with installment payment plan options and increasing customer utilization of available installment payment plans. In this manner, the computing device is used in an unconventional manner and allows real-time installment payment options tailored to each unique consumer in a timely manner, thereby improving the functioning of the underlying computing device at least because the user is likely to use the computing device for extended time period. If the user is not offered dynamically customized installment payment plan incentives, the user may visit different merchant applications and/or websites, which results in more network data usage. The network data usage by the computing device is reduced by the unconventional manner of providing dynamically customized installment payment plan incentives to the user due to which the user will not visit different merchant applications and/or websites.

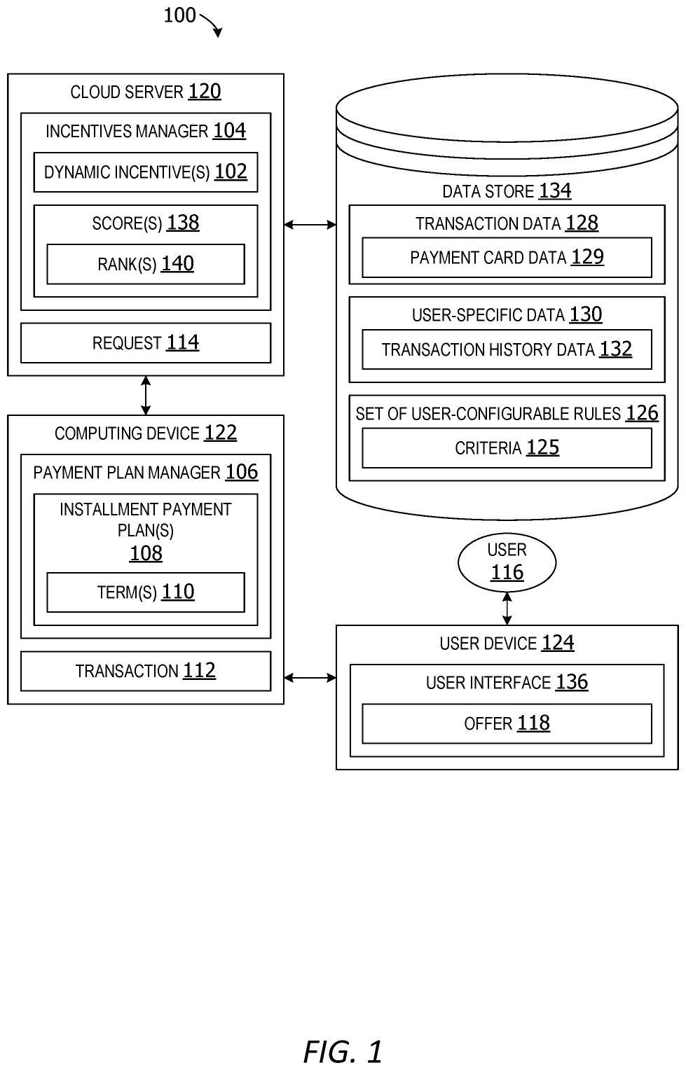

FIG. 1 is an exemplary block diagram illustrating a system 100 for providing dynamic installment payment plan incentives. The system 100 is a system for generating dynamic incentives 102 associated with payment plans customized for each consumer. In some examples, the system 100 is located, stored and/or executed on one or more computing devices, such as a personal computer, server device, tablet computing device, or the like. For instance, a server device may be configured to create, store, and/or select dynamic incentive(s) 102 customized for installment payment plans offered to users.

Alternatively, in other examples, the system 100 is distributed across multiple computing devices, such that components, elements, and/or parts of the system 100 may be located and/or executed on different computing devices that are in communication with each other (e.g., via one or more communication networks, such as internal networks, the Internet, or the like). For instance, the system 100 may be configured to store data associated with operations of an incentives manager 104 on one or more distributed storage devices and/or the system 100 may be configured to execute the incentives manager 104 on one or more distributed computing devices (e.g., the incentives manager 104 is executed on a first server device and the payment plan manager 106 is executed on a second server device. In other examples, other arrangements of computing devices may be used to implement the system 100 without departing from the description.

The dynamic incentive(s) 102 include one or more incentives paired with one or more installment payment plan(s) 108 to improve the term(s) 110 of an installment payment plan, improve user satisfaction with the term(s) of an offered installment payment plan and/or increase the number of installment payment plans which are acceptable to users. An installment payment plan is any type of plan for enabling a user to pay all or a part of the purchase price of an item and/or service in future installments rather than paying the entire purchase price at once when purchasing the item or service.

A dynamic incentive in the one or more dynamic incentive(s) 102 is an incentive that is generated and/or selected in real-time as a user is completing a transaction to purchase one or more good(s) and/or service(s) using an installment payment plan and is based at least in part on the good(s) and/or service(s) to be purchased. An incentive may be referred to as a reward. An incentive includes any type of reward, such as, but not limited to, a coupon, gift certificate, voucher, access pass, membership, gift card, reward points, store credit, cash back, a discount, a free item, or any other type of reward. An example of an incentive includes lounge access at an airport or club. Another example of an incentive includes a gift certificate or voucher for a free or discounted item. Another incentive can include cash back applied to a payment card balance.

The incentives manager 104 includes hardware, firmware, and/or software configured to provide dynamic incentive(s) 102 to the payment plan manager 106 in real-time as the user is completing a purchase transaction 112. The incentives manager 104, in some examples, receives a request 114 for a dynamic incentive associated with an installment payment plan customized for a user 116 during the transaction 112. In some examples, the incentives manager 104 receives the request 114 from the payment plan manager 106.

The payment plan manager 106 includes hardware, firmware, and/or software configured to create an offer 118 including one or more installment payment plan offers with corresponding dynamic incentive(s) 102 for the user 116. In this example, the offer 118 optionally includes one or more installment payment plan(s) 108 with one or more dynamic incentive(s) 102 customized for the user 116. The payment plan manager 106 requests the one or more dynamic incentive(s) 102 from the incentives manager 104. The request 114 is transmitted from the payment plan manager 106 on a computing device 122 to the incentives manager 104 associated with a cloud server 120 via a network.

In this example, the incentives manager 104 is hosted on the cloud server 120. However, the examples are not limited to executing the incentives manager 104 on the cloud server 120. In other examples, the incentives manager 104 is implemented on a computing device, such as, but not limited to, the computing device 122.

The cloud server 120 is a logical server providing services to one or more computing devices or other clients, such as, but not limited to, the computing device 122 and/or the user device 124. The cloud server 120 is hosted and/or delivered via a network. In some non-limiting examples, the cloud server 120 is associated with one or more physical servers in one or more data centers. In other examples, the cloud server 120 is associated with a distributed network of servers.

The network is implemented by one or more physical network components, such as, but without limitation, routers, switches, network interface cards (NICs), and other network devices. The network is any type of network for enabling communications with remote computing devices, such as, but not limited to, a local area network (LAN), a subnet, a wide area network (WAN), a wireless (Wi-Fi) network, or any other type of network.

In this example, the incentives manager 104 is implemented on a cloud server 120 while the payment plan manager 106 is implemented on a separate remote computing device 122. However, in other examples, the incentives manager 104 and the payment plan manager 106 can be implemented on the same cloud server and/or on the same computing device, such as, but not limited to, the computing device 122. In still other examples, both the payment plan manager 106 as well as the incentives manager 104 are provided as cloud-based services provided on a cloud server, such as, but not limited to, the cloud server 120.

In some examples, the incentives manager 104 applies a set of user-configurable rules 126 to transaction data 128 associated with the user 116 and the transaction 112. The set of user-configurable rules 126 is a set of one or more rules, including criteria for generating the dynamic incentive(s) 102. In some examples, the set of user-configurable rules 126 includes one or more rules configured by a lender providing the installment payment plan(s) 108. In other examples, the set of user-configurable rules 126 includes one or more rules configured by the merchant offering the goods and/or services for purchase by the user 116. In still other examples, the set of user-configurable rules 126 includes one or more rules created by an issuer of a payment card presented by the user 116 during the transaction 112.

In other examples, the set of user-configurable rules 126 includes criteria 125 for determining whether the user 116 is eligible to receive an offer including one or more of the dynamic incentive(s) 102 and/or criteria 125 for generating the dynamic incentive(s) 102. In some examples, the criteria 125 includes a merchant preference associated with a type of incentive offered to the user and a value of the incentive offered to the user. In these examples, the criteria 125 are applied by the incentives manager 104 to generate dynamic incentive(s) that conform to the merchant preferences. For example, if the merchant only wants to provide cash back incentives and in-store credit towards future purchases, the incentives manager 104 generates incentives customized for the user 116 which only include the two preferred types of incentives.

The incentives manager 104, in some examples, generates the dynamic incentive(s) 102 for one or more installment payment plan(s) 108 based on application of the set of user-configured rules 126 to the transaction data 128 and/or other user-specific data 130. The transaction data 128 is data describing aspects of the transaction 112, such as, but not limited to, an identification of the item(s) and/or services being purchased, the time of purchase, the date of purchase, the location of purchase, an identification of the merchant, a method of payment, identification of a store/business, webpage associated with an online purchase, total purchase amount and/or any other transaction-related data. The transaction data 128 can also include payment card data 129 associated with a payment card presented by the user. The payment card data 129 includes data associated with the payment card, such as, but not limited to, payment card issuer identification, payment card account number or personal account number (PAN) associated with a payment card, etc.

For example, if a purchase amount of a first transaction is one-hundred dollars and the purchase amount of a second transaction is one-thousand dollars, the second transaction receives better or more valuable incentives than the first transaction due to the greater purchase amount.

In some examples, the transaction data 128 includes dynamic market trends data describing a current event or a seasonal occurrence. A current event could include a sports event, awards ceremony, movie release date, a holiday, etc. A seasonal occurrence includes any time period in which certain activities tend to occur. For example, a holiday season typically involves decorating homes, taking trips, visiting relatives, etc. In another example, the summer season typically involves swimming, going to the beach, vacations, picnics, and other outdoor activities. In still another example, the spring season typically involves yard work, gardening, etc.

In other examples, the transaction data further comprises a payment card category for the payment card submitted by the user 116. The generated dynamic incentive is associated with a set of pre-approved types of incentives associated with the payment card category. The category of the payment card can include the issuer of the card, the store or merchant associated with the payment card, etc. For example, some stores provide customers with an in-store or store-branded payment cards. In another example, a payment card may be classified as a gold card or a platinum card. A user with a platinum payment card may be eligible for better incentives than a non-platinum card holder. In another example, a user that has had a payment card account for five years may be eligible for more benefits than another user that has only had a payment card account for one year.

The set of user-configurable rules 126, in one example, specifies that certain types of incentives are offered if the user provides certain categories of payment cards. In this example, if the payment card is affiliated with a particular store, the incentives may include credit or vouchers for use at the particular store.

The generated dynamic incentive in some examples is associated with the current event or the seasonal occurrence. For example, if the transaction occurs during the summer, the incentive can include tickets to an outdoor concert. In another example, if a sporting event is approaching, the incentive may include a voucher for a sports jersey, etc.

The user-specific data 130 is data associated with the user 116, such as, but not limited to, user preferences, user account data and/or transaction history data of the user. Transaction history data 132 includes data describing previous purchase transactions made by the user. The transaction history data can include data provided by a merchant, an issuer, a lender and/or the user 116. The transaction history data 132, in some examples, includes the date of previous transactions, items purchased during the previous transactions, services purchased during the previous transactions, merchants associated with the previous transactions, locations of the previous transactions, etc. In some examples, the transaction history data is obtained from a payment card issuer. In other examples, the transaction history data is obtained from one or more merchants.

In this example, the transaction data 128, the user-specific data 130 and/or the set of user-configurable rules 126 are stored on a data store 134. The data store 134 includes hardware, firmware, and/or software configured to store data. The data store 134 can be implemented as a remote data storage device, a user device, a cloud storage, or any other data store accessible by the incentives manager 104.

The incentives manager 104, in other examples, generates a plurality of dynamic incentives customized for the user. The incentives manager 104 calculates one or more score(s) 138 for each dynamic incentive in the plurality of dynamic incentives customized for the user. Each score indicates a priority and/or predicted level of desirability of each incentive in the plurality of dynamic incentives to the user. In these examples, a higher score indicates a higher priority associated with an incentive which is more likely to be desirable to a particular user than a lower scored incentive. In other examples, a lower score indicates an incentive which is predicted to be more desirable to a particular user than a higher scored incentive.

In some examples, the score(s) 138 are implemented as any type of score. The score(s) 138 can include an alphanumerical value, a percentage value, a letter grade, or any other type of score. In still other examples, the score(s) 138 are used to rank each incentive. The rank(s) 140 are used to identify the best incentives for each user. The incentives manager 104 selects a dynamic incentive from the plurality of incentives having the highest score or highest rank indicating the incentive most likely to be acceptable or desirable to the user 116. The incentives manager 104 selects the dynamic incentive having the highest score or rank. This selected dynamic incentive is recommended for pairing with the installment payment plan offered to the user. In some examples, the incentives manager 104 selects a threshold number of incentives (e.g., two, five, etc.) having high scores or ranks.

In other examples, the incentives manager 104 presents the offer 118 to the user via a user interface 136 including one or more of the installment payment plan(s) 108 and the generated dynamic incentive(s) 102 customized for the user in real-time during the transaction. The offer 118 is presented to the user 116, in some examples, via the user interface 136 on a user device 124.

The user device 124 represents any device executing computer-executable instructions. The user device 124 can be implemented as a mobile computing device, such as, but not limited to, a wearable computing device, a mobile telephone, laptop, tablet, computing pad, netbook, gaming device, and/or any other portable device. The user device 124 includes at least one processor and a memory.

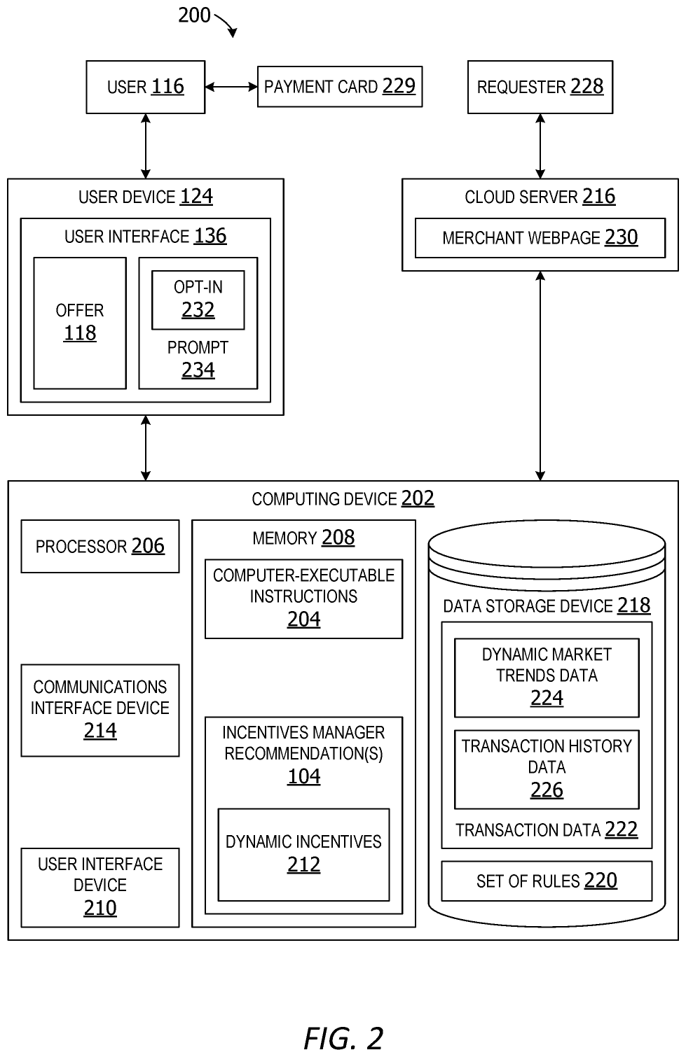

FIG. 2 is an exemplary block diagram illustrating a system 200 for generating per-installment payment plan dynamic incentives customized for each user. In the example of FIG. 2, the computing device 202 represents any device executing computer-executable instructions 204 (e.g., as application programs, operating system functionality, or both) to implement the operations and functionality associated with the computing device 202, such as, but not limited to, the computing device 122 in FIG. 1. The computing device 202, in some examples includes a mobile computing device or any other portable device. A mobile computing device includes, for example but without limitation, a mobile telephone, laptop, tablet, computing pad, netbook, gaming device, and/or portable media player. The computing device 202 can also include less-portable devices such as servers, desktop personal computers, kiosks, or tabletop devices. Additionally, the computing device 202 can represent a group of processing units or other computing devices.

In some examples, the computing device 202 has at least one processor 206 and a memory 208. The computing device 202, in other examples includes a user interface device 210, such as, but not limited to, the user interface 136 in FIG. 1.

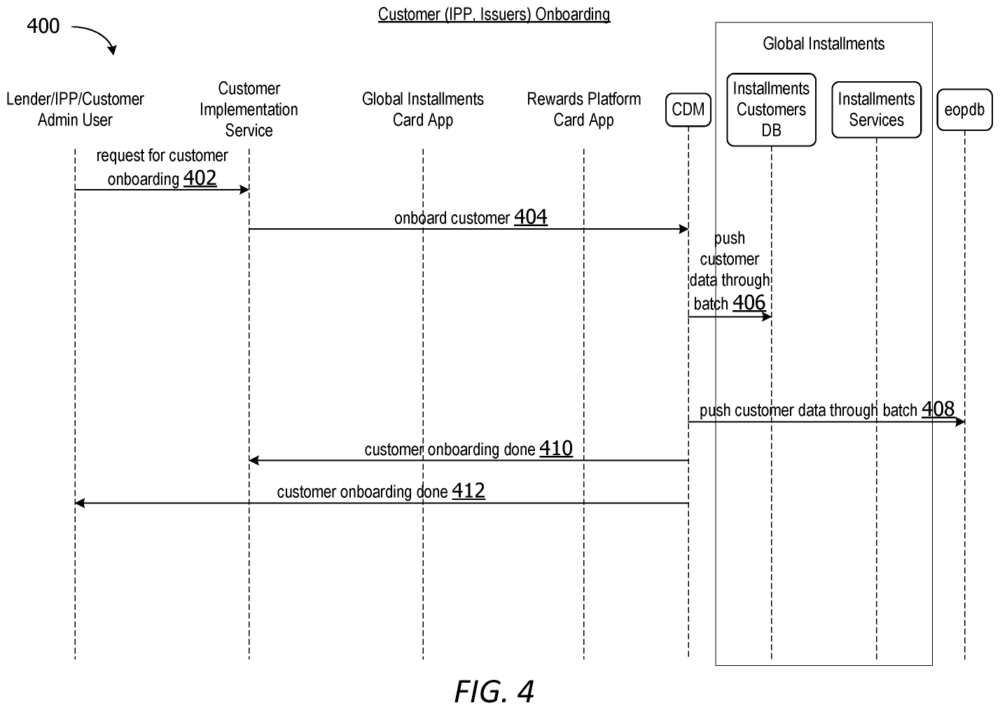

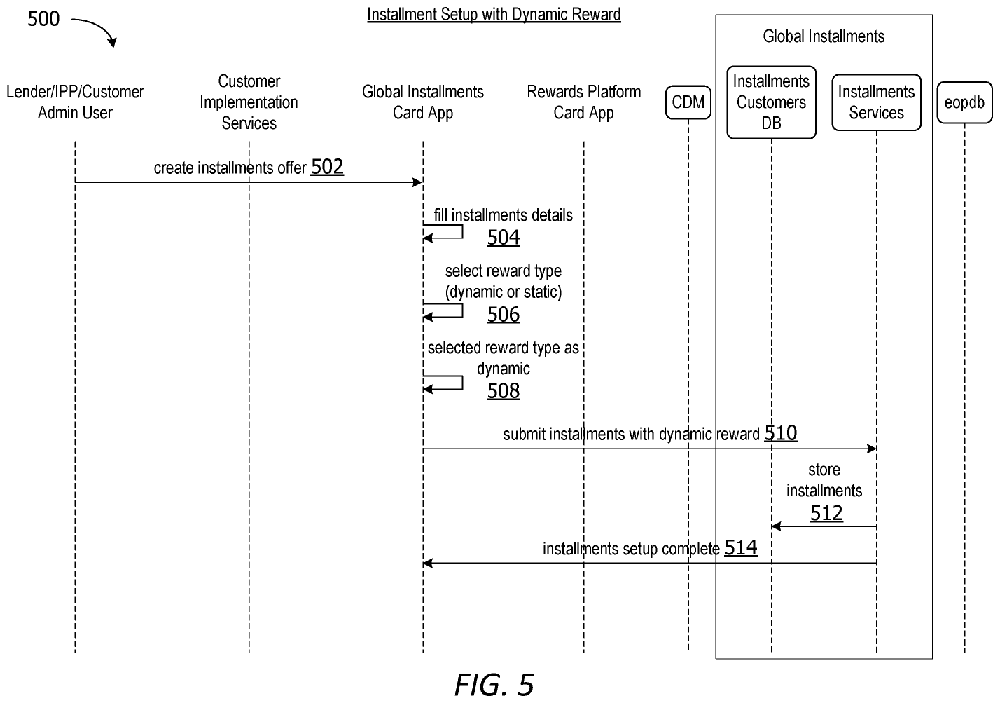

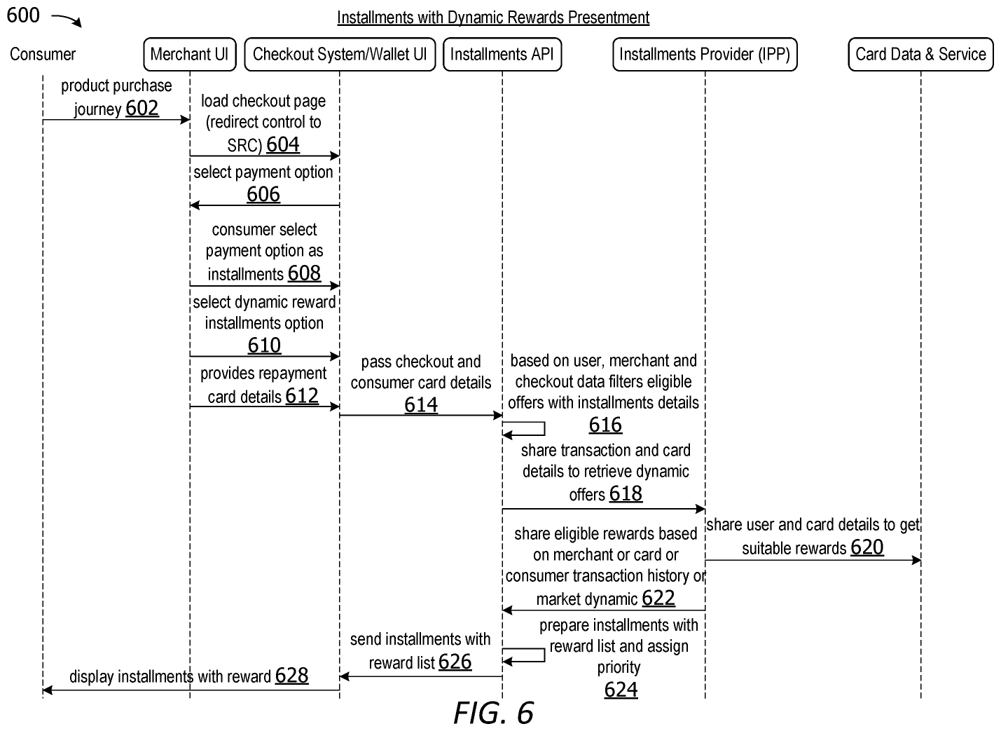

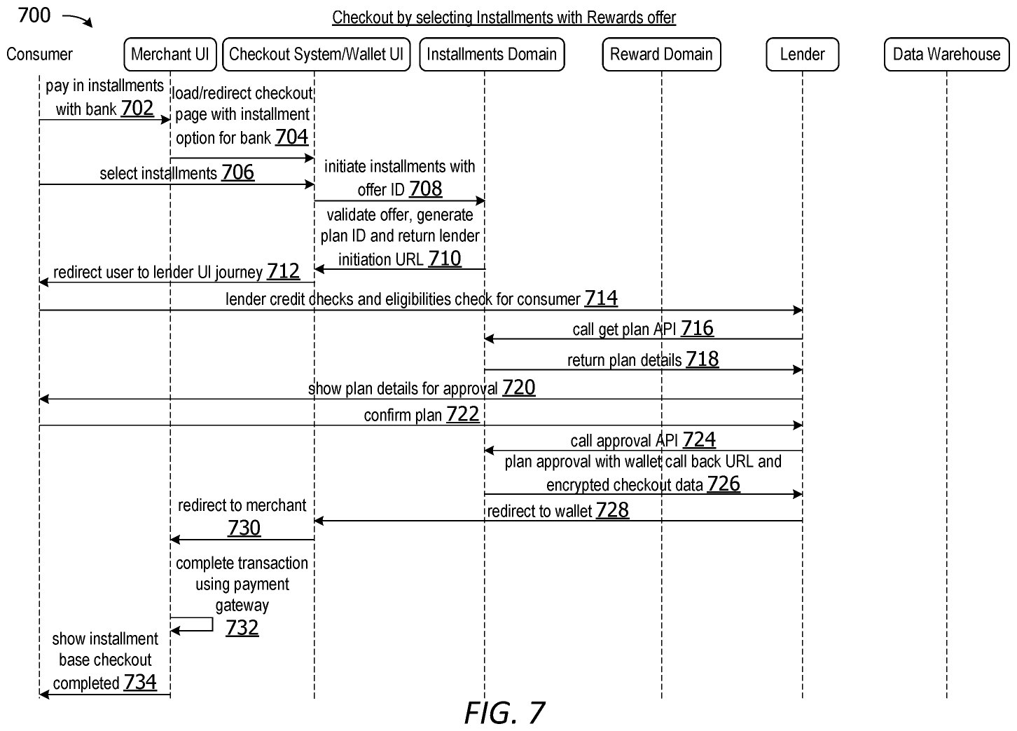

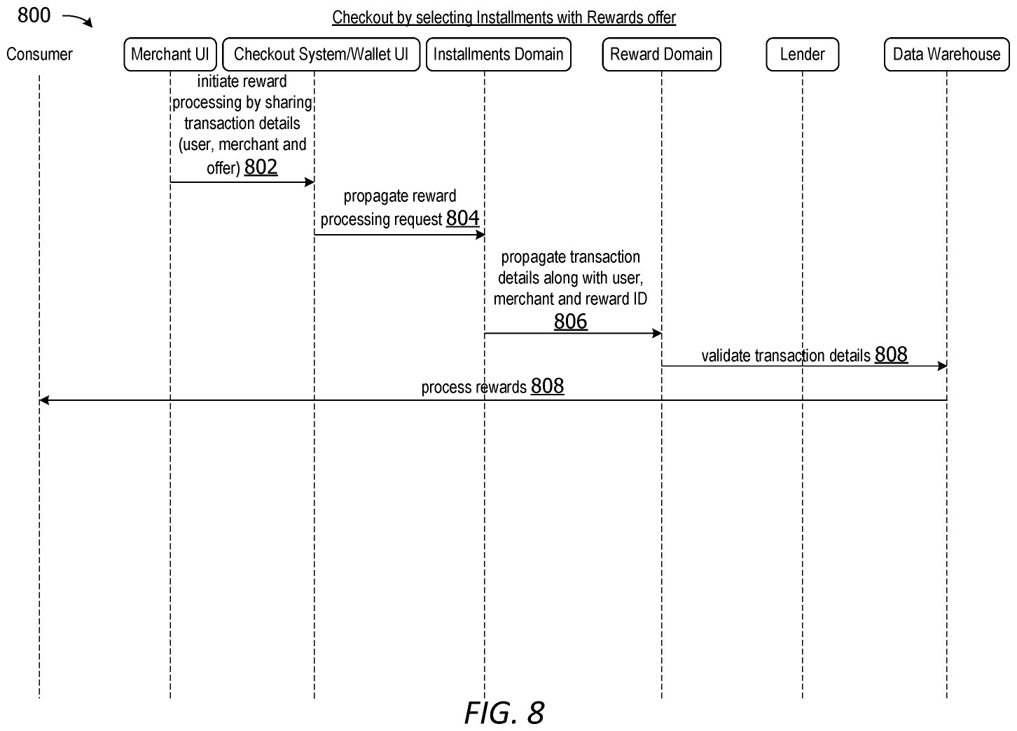

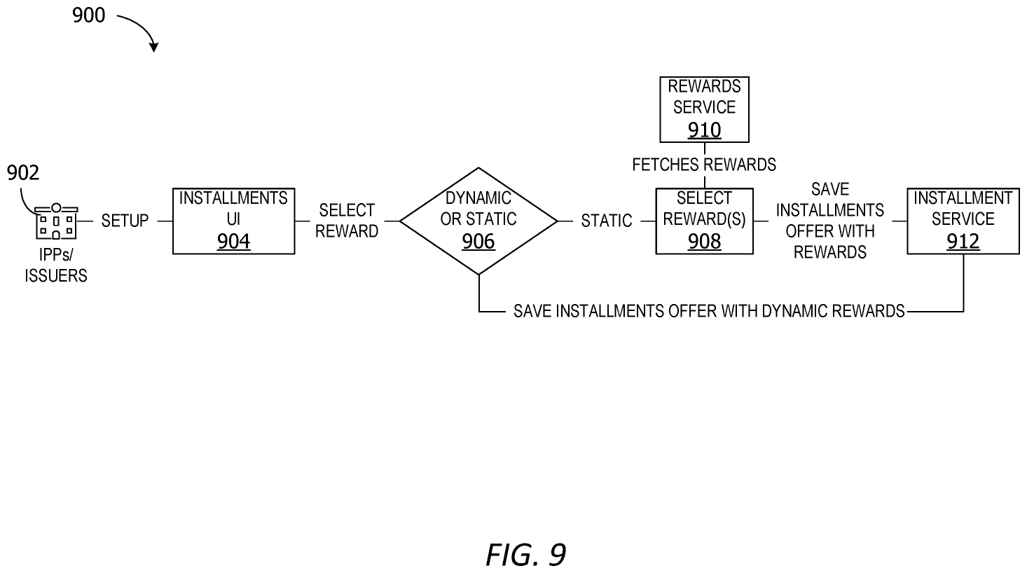

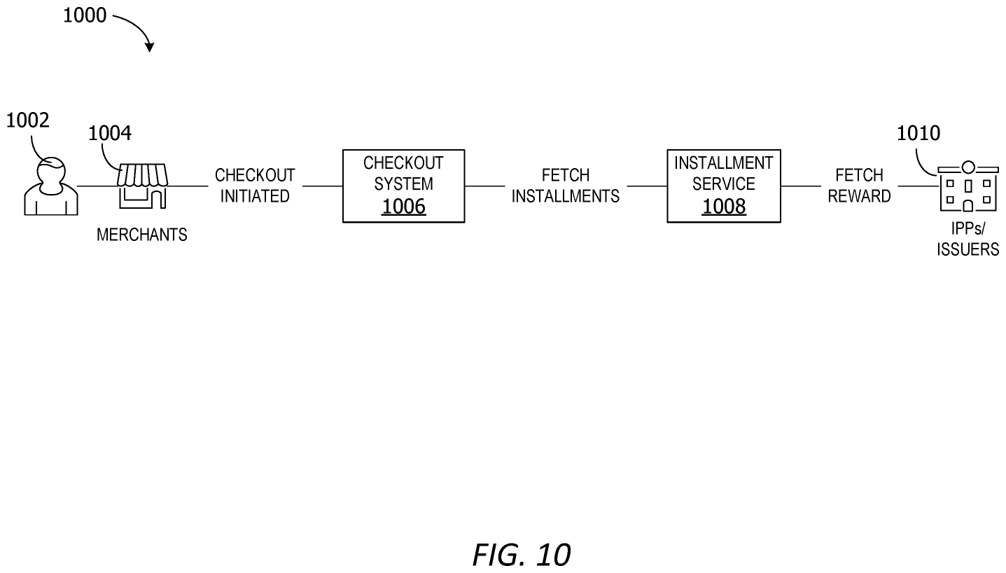

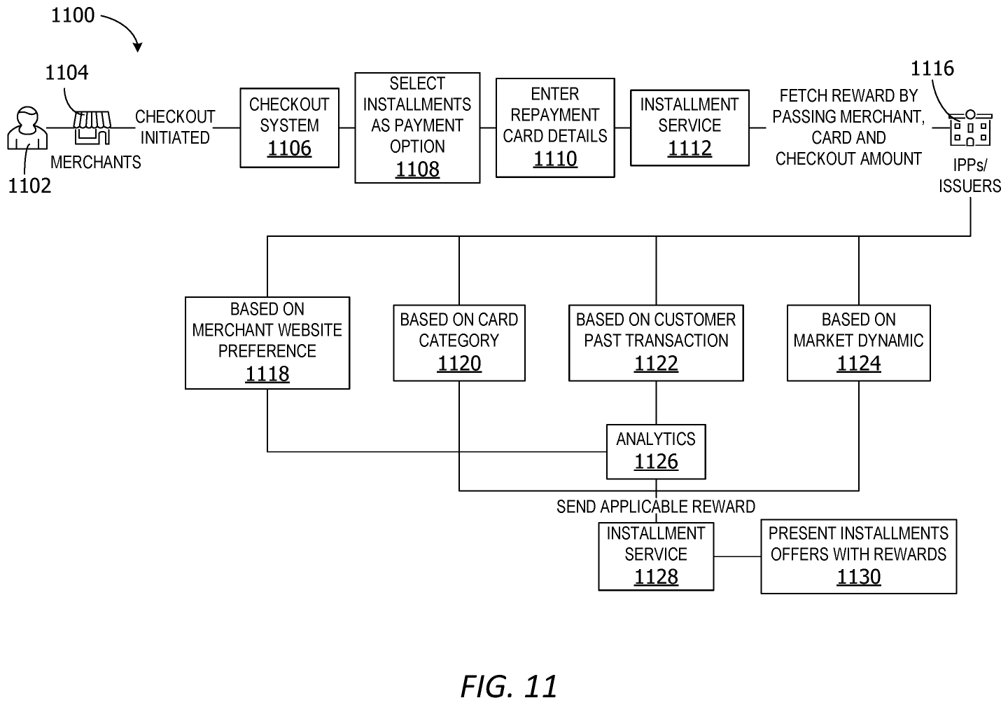

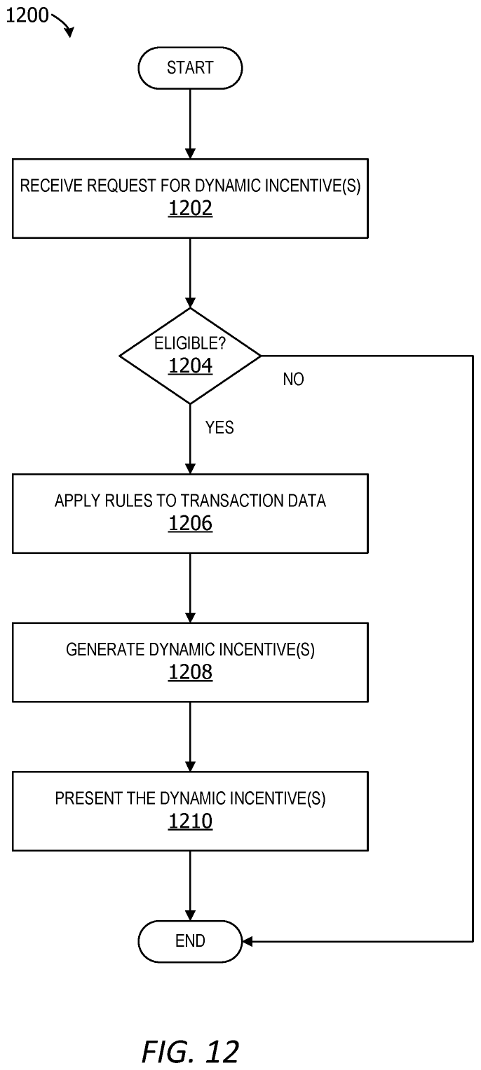

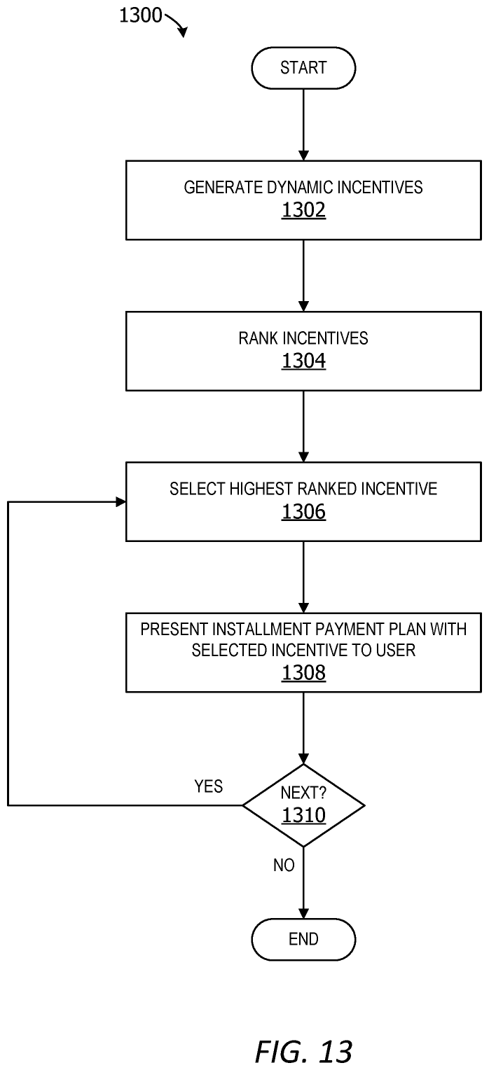

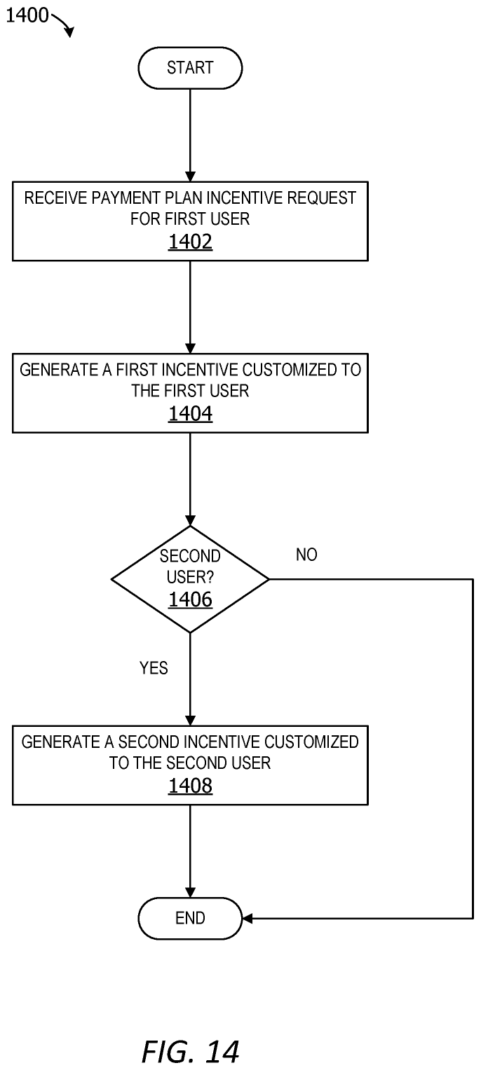

The processor 206 includes any quantity of processing units and is programmed to execute the computer-executable instructions 204. The computer-executable instructions 204 is performed by the processor 206, performed by multiple processors within the computing device 202 or performed by a processor external to the computing device 202. In some examples, the processor 206 is programmed to execute instructions such as those illustrated in the figures (e.g., FIG. 4, FIG. 5, FIG. 6, FIG. 7, FIG. 8, FIG. 9, FIG. 10, FIG. 11, FIG. 12, FIG. 13, and FIG. 14).

The computing device 202 further has one or more computer-readable media such as the memory 208. The memory 208 includes any quantity of media associated with or accessible by the computing device 202. The memory 208, in these examples, is internal to the computing device 202 (as shown in FIG. 2). In other examples, the memory 208 is external to the computing device (not shown) or both (not shown). The memory 208 can include read-only memory and/or memory wired into an analog computing device.

The memory 208 stores data, such as one or more applications. The applications, when executed by the processor 206, operate to perform functionality on the computing device 202. The applications can communicate with counterpart applications or services such as web services accessible via a network. In an example, the applications represent downloaded client-side applications that correspond to server-side services executing in a cloud.

In other examples, the user interface device 210 includes a graphics card for displaying data to the user and receiving data from the user, such as, but not limited to, a dynamic incentive 212. The user interface device 210 can also include computer-executable instructions (e.g., a driver) for operating the graphics card. Further, the user interface device 210 can include a display (e.g., a touch screen display or natural user interface) and/or computer-executable instructions (e.g., a driver) for operating the display. The user interface device 210 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 202 in one or more ways.

In some examples, the system 200 optionally includes a communications interface device 214. The communications interface device 214 includes a network interface card and/or computer-executable instructions (e.g., a driver) for operating the network interface card. Communication between the computing device 202 and other devices, such as but not limited to the user device 124 and/or the cloud server 216, can occur using any protocol or mechanism over any wired or wireless connection. In some examples, the communications interface device 214 is operable with short range communication technologies such as by using near-field communication (NFC) tags.

The cloud server 216 is a logical server providing services to the computing device 202 or other clients, such as, but not limited to, the user device 124. The cloud server 216 is hosted and/or delivered via the network. In some non-limiting examples, the cloud server 216 is associated with one or more physical servers in one or more data centers. In other examples, the cloud server 216 is associated with a distributed network of servers.

The system 200 can optionally include a data storage device 218 for storing data, such as, but not limited to a set of rules 220 and/or transaction data 222. The data storage device 218 can include one or more different types of data storage devices, such as, for example, one or more rotating disks drives, one or more solid state drives (SSDs), and/or any other type of data storage device. The data storage device 218 in some non-limiting examples includes a redundant array of independent disks (RAID) array. In some non-limiting examples, the data storage device 218 provides a shared data store accessible by two or more hosts in a cluster. For example, the data storage device 218 may include a hard disk, a redundant array of independent disks (RAID), a flash memory drive, a storage area network (SAN), or other data storage device. In other examples, the data storage device 218 includes a database.

The data storage device 218, in this example, is included within the computing device 202, attached to the computing device, plugged into the computing device, or otherwise associated with the computing device 202. In other examples, the data storage device 218 includes a remote data storage accessed by the computing device via the network, such as a remote data storage device, a data storage in a remote data center, or a cloud storage.

The transaction data 222 includes data describing aspects of a transaction, such as, but not limited to, the transaction data 128 in FIG. 1. In some examples, the transaction data 222 includes dynamic market trends data 224 describing current events and/or seasonal occurrences, such as the holiday shopping season or a local festival.

The set of rules 220 includes one or more user-configured rules for generating the incentives, such as, but not limited to, the set of user-configurable rules 126 in FIG. 1. The set of rules 220 can include criteria which are applied to user-specific data and/or the transaction data. For example, the set of rules 220 can include payment card category criteria and/or merchant preferences.

In some examples, the incentives manager 104 obtains a request for an installment payment plan incentive customized for a user in real-time from a requester 228. In this example, the request is received via a network. The requester 228, in this example, is a computing system associated with a merchant, issuer or a lender, such as a payment plan manager component executing on a cloud server 216. In this example, the cloud server 216 hosts a merchant webpage 230. The user performs the transaction with the merchant via the merchant webpage 230 to purchase an item or service from a merchant. The merchant webpage provides the user with the option to pay for the goods and/or services using an installment payment plan.

The incentives manager 104 analyzes the transaction data 222 and any other user-specific data using the set of rules 220. The incentives manager 104 generates a dynamic incentive 212 associated with the installment payment plan based on application of the set of user-configured rules to the transaction data. The dynamic incentive 212 is customized to the user. The incentives manager 104 transmits the dynamic incentive 212 to the requester 228. The requester 228 provides an offer to the user 116 via a user interface 136 device for acceptance or rejection. The offer 118 includes at least one installment payment plan and the dynamic incentive 212 customized for the user in real-time during the transaction.

In some examples, the user has to opt-in 232 to receive dynamic incentives 212 with an installment payment plan option in the offer 118. In other examples, the incentives manager 104 outputs a prompt 234 to the user prompting the user to opt-in 232 to receive the dynamic incentives 212 when the user presents a payment card 229 during a payment process associated with the purchase of one or more goods and/or services associated with the transaction. The prompt 234 in some examples is displayed via the user interface 136 on the user device 124. However, in other examples, the prompt 234 may be presented to the user via a point-of-sale (POS) or other merchant checkout computing device.

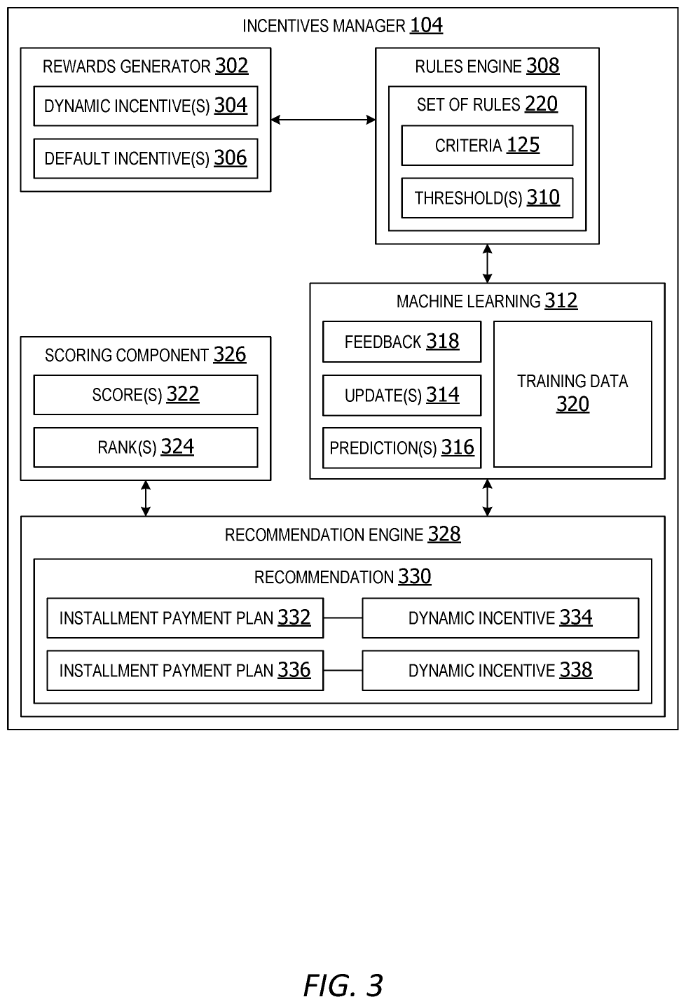

Referring now to FIG. 3, an exemplary block diagram illustrating an incentives manager 104 for generating dynamic incentives for installment payment plans is shown. In some examples, the incentives manager 104 includes a rewards generator 302 for generating dynamic incentive(s) 304 and/or default incentive(s) 306. The dynamic incentive(s) 304 are customized for each user based on application of a set of rules 220 to transaction data and other user-specific data associated with the merchant, issuer of a payment card, lender and/or the consumer purchasing the item and/or services for which the installment payment plan is being offered.

The default incentive(s) 306 include one or more static incentives which are optionally offered to a user with an installment payment plan where the system is unable to generate a dynamic incentive and/or where the user has not opted-in to receive dynamic incentives.

A rules engine 308 is a software component that stores, maintains and/or updates one or more rules for application in generating the dynamic incentive(s) 304 and/or determining whether a user is eligible to receive dynamic incentive(s) 304. In some examples, the set of rules 220 includes one or more user-configurable rules, such as, but not limited to, the set of user-configurable rules 126 in FIG. 1. The set of rules 220 includes criteria 125 for generating the incentives. For example, the set of rules 220 may include criteria specifying that installment payment plans having no fees or other costs associated with the payment plan should not be given any additional incentives while payment plans associated with higher fees or interest rates should be given more beneficial incentives.

The set of rules 220 optionally includes one or more threshold(s) 310 for determining whether to provide a dynamic incentive for a given transaction. For example, the threshold(s) 310 can include a minimum transaction amount. If the total transaction amount for a given transaction is less than the threshold minimum transaction amount, the transaction is not eligible for a dynamic incentive. If the total transaction amount is equal to or greater than the threshold minimum transaction amount, the transaction is eligible for an installment payment plan with a dynamic incentive.

In other examples, the incentives manager 104 includes a machine learning (ML) 312 component. The ML 312 may include pattern recognition, modeling, or other machine learning algorithms to analyze transaction data and/or other available database information to generate update(s) 314 to the set of rules 220. The update(s) 314 refine the rules to improve the generated incentives and increase the acceptance rate of installment payment plans by consumers. Thus, the ML 312 updates one or more rules in the set of rules 220 used to the generate the dynamic incentive to improve the overall acceptance rate associated with installment payment plans.

In other examples, the ML 312 generates prediction(s) 316 associated with acceptance rates of the installment payment plans accompanied by dynamic incentives. The ML 312 may utilize the prediction(s) to update the rules, generate score(s) 322 and/or rank(s) 324 indicating which dynamic incentive(s) are most likely to be desirable to each user based on the user-specific data available to the ML 312 component.

In still other examples, the ML 312 component is trained using training data 320. The training data 320, in some examples, includes examples of incentives provided to various consumers associated with different types of transactions for different types of products and/or services. The training data enables the ML 312 to learn which types of incentives to offer to which types of consumers and/or types of transactions. The training data is further utilized by the ML 312 to learn which types of installment payment plans should be afforded an incentive and which types of payment plans should not receive an incentive.

In still other examples, one or more users may provide feedback 318 to the ML 312 component. The feedback is used to refine the set of rules and/or the prediction(s) 316 generated by the ML 312. The feedback 318 is provided by any user associated with the system, such as, but not limited to, the consumer, the merchant, the issuer of a payment card, and/or the lender.

The incentives manager 104, in some examples, includes a scoring component 326 that generates score(s) 322 associated with the user and/or the dynamic incentive(s) 304 generated by the rewards generator 302. In some examples, the scoring component 326 generates a score associated with a given user and/or a given transaction. The score is used to determine whether the transaction is eligible for an installment payment plan and/or a dynamic incentive. For example, if the transaction amount is too low, the score for the transaction would be a low score indicating the transaction is ineligible for a dynamic incentive. In another example, if the user has already made several purchases on installment payment plans within a relatively short period of time (threshold time-period), the scoring component generates a score indicating the user is ineligible for another incentive due to the number of incentives already issued to the user.

In still other examples, the rank(s) 324 are used to select a dynamic incentive for a given user. In these examples, the incentives manager 104 generates a plurality of dynamic incentives customized for the user. The scoring component 326 calculates a score for each dynamic incentive in the plurality of dynamic incentives customized for the user. Each score indicates a predicted level of desirability of each incentive in the plurality of dynamic incentives to the user. The incentives manager 104 selects a dynamic incentive from the plurality of incentives having a highest score, wherein the selected dynamic incentive is recommended for pairing with the installment payment plan offered to the user.

The incentive manager 104, in some examples, includes a recommendation engine 328. The recommendation engine 328 generates a recommendation 330 including one or more installment payment plans and one or more dynamic incentives for each payment plan. In this example, the recommendation includes a first installment payment plan 332 paired with a first dynamic incentive 334 and a second installment payment plan 336 paired with a second dynamic incentive 338. The recommendation is transmitted to the requester. The requester determines whether to present the installment payment plans with the dynamic incentives to the consumer.

Referring now to FIG. 4, an exemplary data flow illustrating a process 400 for onboarding a new customer into the dynamic incentives services system is shown. In this example, a requester makes a request to a customer implementation service for customer onboarding at 402. The requester is a lender, installment payment provider, and/or a customer administration user. The customer is onboarded into the incentives system at 404. The onboarding process includes providing data, such as customer details, business relationships, business to business relationships product associations and/or account range. The customer data is pushed through batch from the customer data management (CDM) to the installments customers database (DB) at 406 and to the equipment-oriented publications database (eopdb) at 408. A notification is sent indicating customer onboarding is done at 410. The notification that the customer onboarding is done is provided to the requester at 412.

FIG. 5 is an exemplary data flow illustrating a process 500 for installment payment process setup with dynamic incentives. In this example, the requester (lender, installment payment provider (IPP), customer, admin user, etc.) creates the installments at 502, such as by proposing an installment offer. The global installments payment card application fills in the installment details corresponding to the installments offer at 504. The global installments payment card application selects the reward type (dynamic or static) at 506. A static reward is a default incentive. The global installments payment card application selects the reward type as dynamic at 508. The global installments payment card application submits installments with the dynamic reward at 510. The installments service stores the installments at 512. The installments service includes the incentives manager for generating the dynamic incentives. The installments service notifies the global installments payment card application that the installments setup is completed at 514.

FIG. 6 is an exemplary data flow illustrating a process 600 for installment payment plans with dynamic incentives presentment. A consumer begins the product purchase journey at 602 (e.g., by selecting a good or service on a merchant application or website). The merchant UI is used to load a checkout page redirecting control to the merchant checkout at 604. The merchant checkout/wallet UI displays selected installment payment plan options to the consumer via the merchant UI at 606. The consumer selects an installment payment plan from the options at 608. The consumer provides repayment card details at the merchant checkout at 612. The merchant checkout system passes the checkout and consumer payment card details to an installments application programming interface (API) at 614. User, merchant, and checkout data are used to filter eligible offers with installment details at 616. Transaction and payment card details are shared to retrieve dynamic offers at 618. The shares user and payment card details to get suitable rewards (incentives) at 620. Eligible rewards are shared based on merchant, payment card, transaction history or market dynamics at 622. Installment payment plans are prepared with a reward list and assigned priority using scores and/or rankings at 624. The installment payment plans with the reward list (selected dynamic incentives) are sent to the user at 626. The installment payment plan(s) and reward are displayed to the user via the merchant UI at 628.

FIG. 7 is an exemplary data flow illustrating a process 700 for checkout by selecting installments with dynamic incentives offers. A consumer pays in installments using an account, such as a bank account at 702. The merchant UI loads or redirects to a checkout page of the merchant website with installment options for the account at 704. The consumer selects an installment payment plan at 706. The selected installment payment plan is initiated using an offer identifier (ID) at 708. The offer is validated, an installment payment plan ID is generated and return lender initiation uniform resource locator (URL) at 710. The user is redirected to lender UI journey at 712. The lender performs a credit check and an eligibility check for the consumer at 714. The lender calls a get installment payment plan API at 716. Installment payment plan details are returned at 718. The lender presents the installment payment plan details to the consumer for approval at 720. The consumer confirms the installment payment plan at 722. The lender system calls a plan approval API at 724. The installment payment plan gets approval with wallet call back URL and encrypted checkout data at 726. The system redirects to the merchant/wallet at 728. The system redirects to the merchant UI at 730. The transaction completes using a payment gateway at 732. The merchant UI shows installment payment plan details and checkout completes at 734.

FIG. 8 is an exemplary data flow illustrating a process 800 for merchant-initiated rewards processing. A reward processing is initiated by sharing transaction details (user, merchant and/or offer) at 802. The reward processing request is propagated from the merchant system via the installments domain at 804 to the lender system at 806. The transaction details are validated at 808. The rewards are processed at 810.

FIG. 9 is an exemplary process flow 900 illustrating dynamic incentives setup. The IPP and/or an issuer 902 of a payment card performs customer onboarding via an installments UI 904. The user selects a reward (incentive). A determination is made whether the reward is dynamic or static at 906. If it is static, the system selects the default reward(s) at 908. The rewards are fetched from a reward service at 910. The reward service includes an incentives manager, such as the incentives manager 104 in FIG. 1, FIG. 2, and FIG. 3. The system saves offers, including at least one installment payment plan and at least one reward with an installment service at 912. If the reward is dynamic, the offer includes at least one installment payment plan with at least one dynamic reward (dynamic incentive) saved by the installment service at 912. The installment service includes a payment plan manager, such as, but not limited to, the payment plan manager 106 in FIG. 1.

FIG. 10 is an exemplary process flow 1000 illustrating dynamic incentives generation by an installment service. In this example, a consumer 1002 engages in a transaction with a merchant 1004. The merchant checkout system 1006 (e.g., Secure Remote Commerce, or other system) fetches installment payment plans from an installment service 1008 associated with a lender or issuer 1010.

FIG. 11 is an exemplary process flow 1100 illustrating dynamic incentives generation customized for a user based on a user payment card. In this example, a consumer 1102 is performing a transaction to purchase goods or services from a merchant 1104. The consumer interacts with the merchant checkout system 1106 to select installment payments as the preferred payment option to complete the transaction at 1108. Repayment card details are entered by the consumer or the merchant system at 1110. The installment service 1112 fetches a reward by passing merchant, payment card and checkout amount to the IPPs and/or issuers at 1116. The incentives manager uses merchant website preference data 1118, payment card category 1120, customer past transactions 1122 and/or dynamic market trends 1124 to generate dynamic incentives and/or static incentives from analytics data at 1126. The applicable reward is sent by an installment service 1128. The installment payment plan offer with the reward(s) is presented to the consumer at 1130.

In some examples, the website preference data 1118 includes data that describes one or more websites frequented by the customer. If the user is booking a flight every week or purchasing few tickets a month the system may generate a reward related to air travel, the airlines, or other travel-related incentives.

The payment card category 1120 refers to the payment card submitted by the customer. If the customer is using a payment card associated with a bank, the user might be eligible for an incentive, or a better incentive based on the payment card. The dynamic market trends refer to current events, trends, and/or seasonal activities.

In other examples, the past transaction history refers to data describing aspects of previous transactions. If the transaction history indicates the customer frequents a particular store or merchant, the incentive might be related to the frequently visited store or merchant. For example, if the customer often visits a local coffee shop, an incentive customized for the customer can include a discount or gift card which can be used at the local coffee shop.

In another example, an IPP or issuer sets up installment payments via an installments UI associated with a lender. The installment payment plans are stored with reward IDs by the installment service (incentives manager). The merchant requests rewards from the installment service at the time of customer checkout. When checkout is initiated, the merchant system fetches the installment payment plan with the dynamic reward(s). Reward redemption occurs via a rewards service in this example. The reward redemption may occur at the time of checkout/transaction completion or at a later reward redemption date/time.

FIG. 12 is an exemplary flow chart illustrating the operation of the computing device to provide dynamic installment payment plan incentives customized for a user. The process shown in FIG. 12 is performed by an incentives manager, executing on a computing device, such as the computing device 122 in FIG. 1 and/or the computing device 202 in FIG. 2.

A request for dynamic incentive(s) is received at 1202. An incentives manager makes a determination whether the user and/or the transaction is eligible for dynamic incentive(s) at 1204. The incentives manager is a software component for generating customized incentives, such as, but not limited to, the incentives manager 104 in FIG. 1. If yes, the set of user-configurable rules are applied to transaction data at 1206. Dynamic incentive(s) are generated at 1208. The dynamic incentive(s) are presented to the requester at 1210. The process terminates thereafter.

While the operations illustrated in FIG. 12 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary flow chart illustrating the operation of the computing device to present a user with dynamic incentives predicted to be of greatest interest to the user. The process shown in FIG. 13 is performed by an incentives manager, executing on a computing device, such as the computing device 122 in FIG. 1 and/or the computing device 202 in FIG. 2.

Dynamic incentives are generated by an incentives manager at 1302. The incentives are ranked at 1304. The ranking indicates a prioritization of the incentives based on which incentives are predicted to be of greatest interest to the consumer and/or have the greatest likelihood or probability of installment plan acceptance. The incentives manager selects the highest ranked incentive at 1306. The installment payment plan is presented to the user with the selected incentive at 1308. A determination is made whether a next installment payment plan is to be presented at 1310 (e.g., if the user declines the presented plan). If yes, a next highest ranked incentive is selected at 1306. The next highest ranked incentive is presented with the next installment payment plan at 1308. The process iteratively performs operations 1306 through 1310 until the user has selected a plan, there are no remaining payment plans, or other termination conditions. The process terminates thereafter.

While the operations illustrated in FIG. 13 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

FIG. 14 is an exemplary flow illustrating the operation of the computing device to generate a customized installment payment plan incentive for each user. The process shown in FIG. 14 is performed by an incentives manager, executing on a computing device, such as the computing device 122 in FIG. 1 and/or the computing device 202 in FIG. 2.

A request for a payment plan incentive is received for a first user at 1402. A first incentive is generated that is customized for the first user at 1404. A determination whether a second user requires an incentive for a payment plan is made at 1406. If yes, a second incentive customized to the second user is generated at 1408. The process terminates thereafter.

While the operations illustrated in FIG. 14 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

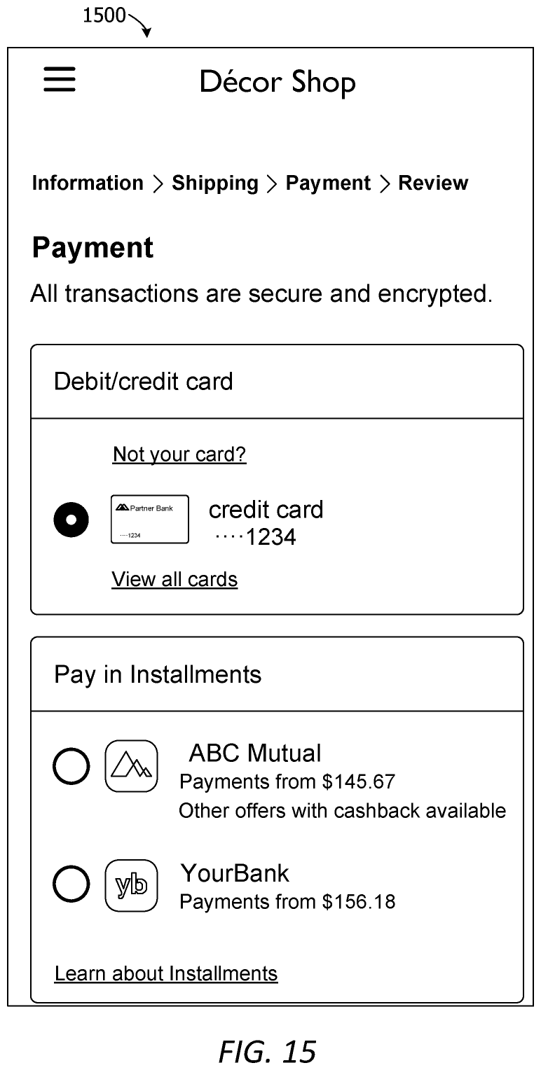

FIG. 15 is an exemplary screenshot including a UI 1500 presenting an installment payment plan option to a user during a transaction. In this example, the user utilizes the UI to select an option to pay an amount due for a transaction using an installment payment plan. In this example, different lenders providing payment plans are displayed. The user selects one of the lenders.

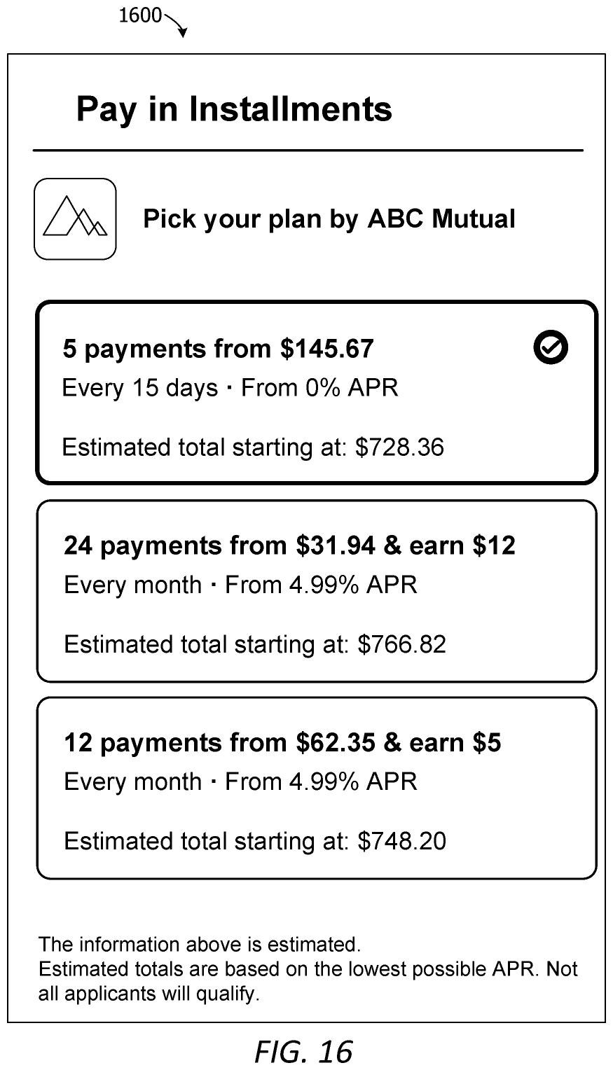

FIG. 16 is an exemplary screenshot including a UI 1600 presenting installment payment plan options with dynamic incentives customized for the user. Different payment plan offers with different payment periods and varying fee amounts are displayed to the user via the UI. Different incentives are associated with each payment plan. The user is able to view the terms of each installment payment plan with any offered incentives. The incentives are selected based on customer transaction history, merchant website, analysis of market trend, transaction data and/or installment payment plan terms, such as, but not limited to, the number of payments, time-period for repayment, percentage interest rate, lender ID, total purchase price, etc.).

The recommended incentives are provided to the merchant or lender. The merchant or lender decides which incentives to offer to the customer.

In this example, the system presents three installment payment plan options to the user. The first installment payment plan does not include an incentive as the first installment payment plan does not include any fees or other costs associated with the plan. The second payment plan option includes a twelve-dollar cash back incentive. The third payment plan option includes a five-dollar cash back incentive. In this example, the second payment plan includes an incentive having a higher value because the second payment plan is associated with higher fees than the first or third payment plan options. In this manner, each incentive is customized to the consumer, the merchant, the transaction and/or the installment payment plan terms, such that the type of incentive and value of the incentives vary depending on the details of each installment payment plan offered to each user.

### Exemplary Operating Environment

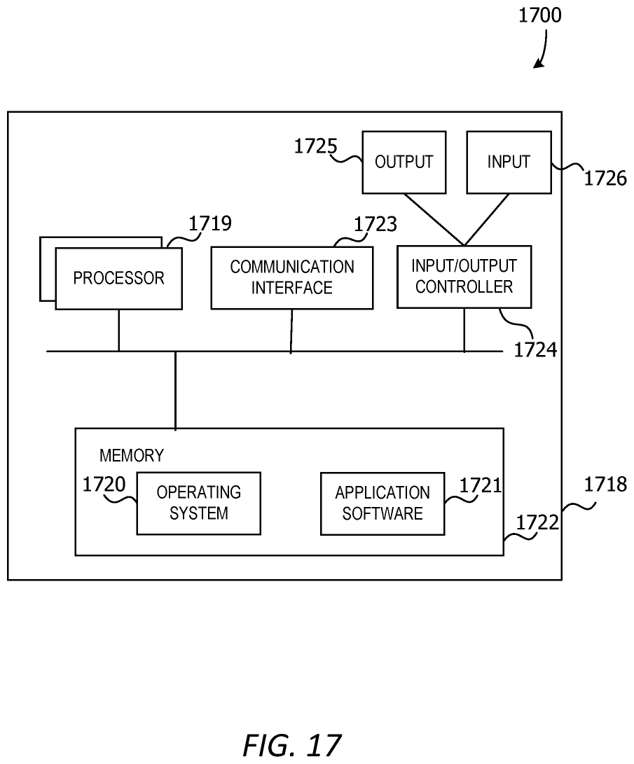

The present disclosure is operable with a computing apparatus according to an embodiment as a functional block diagram 1700 in FIG. 17. In an example, components of a computing apparatus 1718 are implemented as a part of an electronic device according to one or more embodiments described in this specification. The computing apparatus 1718 is a computing device, such as, but not limited to, the computing device 122 in FIG. 1 and/or the computing device 202 in FIG. 2.

The computing apparatus 1718 comprises one or more processors 1719 which can be microprocessors, controllers, or any other suitable type of processors for processing computer executable instructions to control the operation of the electronic device. Alternatively, or in addition, the processor 1719 is any technology capable of executing logic or instructions, such as a hardcoded machine. In some examples, platform software comprising an operating system 1720 or any other suitable platform software is provided on the apparatus 1718 to enable application software 1721 to be executed on the device. In some examples, receiving and routing RPC messages from external sources to microservice rails of a microservice platform as described herein is accomplished by software, hardware, and/or firmware.

In some examples, computer executable instructions are provided using any computer-readable medium or media accessible by the computing apparatus 1718. Computer-readable media include, for example, computer storage media such as a memory 1722 and communications media. Computer storage media, such as a memory 1722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1722) is shown within the computing apparatus 1718, it will be appreciated by a person skilled in the art, that, in some examples, the storage is distributed or located remotely and accessed via a network or other communication link (e.g., using a communication interface 1723).

Further, in some examples, the computing apparatus 1718 comprises an input/output controller 1724 configured to output information to one or more output devices 1725, for example a display or a speaker, which are separate from or integral to the electronic device. Additionally, or alternatively, the input/output controller 1724 is configured to receive and process an input from one or more input devices 1726, for example, a key board, a microphone, or a touchpad. In one example, the output device 1725 also acts as the input device. An example of such a device is a touch sensitive display. The input/output controller 1724 in other examples outputs data to devices other than the output device, e.g., a locally connected printing device. In some examples, a user provides input to the input device(s) 1726 and/or receives output from the output device(s) 1725.

The functionality described herein can be performed, at least in part, by one or more hardware logic components. The computing apparatus 1718 is configured by the program code when executed by the processor 1719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### ADDITIONAL EXAMPLES

In some examples, when a customer wants to opt-in for installment payments at checkout, the customer is presented with installment options from different providers/banks/financial institutions. Incentives are provided with one or more of the payment plan options to encourage more customers to accept the installment payment plans. Different incentives are offered based on different variables and dynamic features associated with each transaction.

For example, if a customer of a Bank A requests an installment payment plan, the Bank A might offer a payment plan with an incentive of 2% cash back on the first installment payment amount.

In another example, if a user likes to travel and frequently books air travel, the system can offer an incentive in conjunction with an airline, such as lounge access or frequent flyer points to attract more customers towards utilizing the installment payment plan options.

In other examples, the system provides customers with customized payment plan offers including incentives tailored to each user's personal interests to encourage the customers to enroll in a particular payment plan while providing the customer with desired benefits and/or rewards.

In another example, where two different lenders are offering installment payment plans with similar terms, if a first lender offers an incentive with the payment plan and the second lender does not offer an incentive, then the first lender is more likely to be selected by the customer. Moreover, if both lenders offer an incentive but the first lender provides a customized incentive tailored to the customer's interests and the second lender provides a generic or default incentive that is not tailored to the customer's interests, the customer will again be more likely to select the first lender's payment plan rather than the second lender, increasing the first lender's market share while increasing customer satisfaction and goodwill.

In some examples, an incentive manager is provided that generates the incentives dynamically based on transaction data and other data associated with the merchant, issuer, lender and/or the user. The incentives manager can be associated with a lender system, a merchant system, a payment card issuer system or implemented as an independent system which provides the incentives to the merchant, lender and/or issuer upon request. In some examples, the lender receives recommended incentives from the incentives manager. The lender selects one or more of the recommended incentives for presentation to the user.

In an example scenario, a customer frequently books flights through a travel booking website and makes payment with a platinum payment card. The payment card issuer offers lounge access to the customer as an incentive if the customer opts to pay for a purchase with installment payments. In this manner, the system customizes dynamic incentives based on merchant websites visited by the user.

In another example, a customer that has a diamond payment card uses it multiple times across different merchants. The payment card issuer offers the customer cash-back on purchase payments. The cash-back amount offered varies depending on the installment payment amount, payment card category, etc. In this manner, incentives are generated based on the payment card category.

In other examples, the system analyzes past transaction history to identify suitable reward options for the customer. For example, if the customer frequently uses a payment card to purchase books at a given bookstore, an incentive can include a gift card, voucher, or discount to be applied to future purchases at the given bookstore. Thus, the customer's past transactions data can be analyzed to generate and/or prioritize incentives offered to the customer to maximum customer acceptance of installment payment plan terms while providing the customers with desired benefits and rewards.

In another example scenario, a user purchasing a sofa a week prior to Thanksgiving and opting to pay with an installment payment plan can be offered a gift card for a grocery store and/or provided a voucher for use in purchasing a ham or turkey as a holiday-themed reward appropriate for the season. In this manner, dynamic market trends data is applied to generate and/or select incentives for customers.

The system enables provision of dynamic rewards for users in the buy now pay later (BNPL) field. Dynamic services are used to identify a score for the user based on the payment card and/or other transaction data. The IPP has an option to offer dynamic rewards to the user based on the scoring they get from this and other services.

In other examples, a user that wants to purchase an item publishes payment card data to the system. The system generates a score for the user based on the payment card data using payment card issuer services. The system offers dynamic rewards to the user based on the score at merchant checkout. In this manner, data is obtained from a plurality of sources and coordinated among parties to provide dynamic incentives calculated in real-time at checkout. The customized incentives further provide increased installment payment adoption by customers, new customer acquisition, increased customer lifetime value (CLV), as well as increased customer retention.

Alternatively, or in addition to the other examples described herein, examples include any combination of the following:
the set of user-configured incentives criteria further comprises a merchant preference associated with a type of incentive offered to the user and a value of the incentive offered to the user, wherein the generated dynamic incentive conforms to the merchant preference:
the transaction data further comprises dynamic market trends data describing a current event or seasonal occurrence, and wherein the generated dynamic incentive is associated with the current event or the seasonal occurrence:
the transaction data further comprises payment card category, wherein the generated dynamic incentive is associated with a set of pre-approved types of incentive associated with the payment card category:
the transaction data further comprises transaction history data describing at least one item previously purchased by the user or service previously purchased by the user, wherein the generated dynamic incentive is associated with a credit or discount for the item or the service:
generate a plurality of dynamic incentives customized for the user:
calculate a score for each dynamic incentive in the plurality of dynamic incentives customized for the user, wherein each score indicates a predicted level of desirability of each incentive in the plurality of dynamic incentives to the user:
select a dynamic incentive from the plurality of incentives having a highest score, wherein the selected dynamic incentive is recommended for pairing with the installment payment plan offered to the user:
update, by a machine learning component, at least one rule in the set of user-configured rules used to generate the dynamic incentive to improve an acceptance rate associated with installment payment plans:
generating a plurality of dynamic incentives customized for the user;
calculating a score for each dynamic incentive in the plurality of dynamic incentives customized for the user, wherein each score indicates a predicted level of desirability of each incentive in the plurality of dynamic incentives to the user:
selecting a dynamic incentive from the plurality of incentives having a highest score, wherein the selected dynamic incentive is recommended for pairing with the installment payment plan offered to the user:
updating, by a machine learning component, at least one rule in the set of user-configured rules used to the generated the dynamic incentive to improve an acceptance rate associated with installment payment plans:
executing an incentives manager associated with a cloud server, by an application programming interface (API) to generate a plurality of dynamic incentives corresponding to a plurality of payment plan options customized for the user, the plurality of payment plan options comprising a first installment payment plan and a second installment payment plan available from the merchant or the lender:
presenting an offer to the user via a user interface, wherein the offer comprises the first installment payment plan paired with a first dynamic incentive and the second installment payment plan paired with a second dynamic incentive:
analyzing user-specific data associated with the user and transaction data associated with the transaction:
generating an eligibility score based on a result of the analysis of the user-specific data and the transaction data:
providing an installment payment plan to the user with a default incentive in response to the eligibility score indicating the user is ineligible;
providing the installment payment plan to the user with a dynamic incentive customized to the user in response to the eligibility score indicating the user is eligible for dynamic incentives:
selecting an incentive from a plurality of incentives based on a set of preferences, the set of preferences comprising at least one of a set of merchant preferences, a set of lender preferences, a set of issuer preferences, or a set of user preferences:
prompting a user to opt-in to a dynamic incentives service via a user device;
onboarding the user into the dynamic incentives service in response to the user selecting an option to opt-in, wherein dynamic incentives are generated for the user:
generate a plurality of dynamic incentives customized for the user:
calculate a score for each dynamic incentive in the plurality of dynamic incentives customized for the user, wherein each score indicates a predicted level of desirability of each incentive in the plurality of dynamic incentives to the user:
select a dynamic incentive from the plurality of incentives having a highest score, wherein the selected dynamic incentive is recommended for pairing with the installment payment plan offered to the user:
generate a first dynamic incentive associated with a first installment payment plan customized for the user;
generate a second dynamic incentive associated with a second installment payment plan customized for the user:
present an offer to the user via a user interface device, wherein the offer comprises the first dynamic incentive paired with the first installment payment plan and the second dynamic incentive paired with the second installment payment plan:
provide an installment payment plan offer in an absence of an incentive in response to a total transaction amount of the transaction falling below a minimum threshold amount:
provide the installment payment plan offer with the dynamic incentive in response to the total transaction amount of the transaction exceeding the minimum threshold amount:
generate a first dynamic incentive for the installment payment plan to a first user; and
generate a second dynamic incentive for the installment payment plan to a second user, wherein the first dynamic incentive is a different incentive than the second dynamic incentive, and wherein the first dynamic incentive is customized to the first user based on user-specific data associated with the first user, and wherein the second dynamic incentive is customized to the second user based on user-specific data associated with the second user.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for dynamic installment payment plan incentives: obtain a request for a dynamic incentive for an installment payment plan customized for a user in real-time during a transaction: analyze transaction data associated with the transaction using a set of user-configured rules, the set of user-configured rules comprising a set of user-configured incentives criteria comprising at least one of a merchant preference or at least one payment card category criteria, the transaction data comprising at least one of dynamic market trends data or user transaction history data; and generate a dynamic incentive associated with the installment payment plan based on application of the set of user-configured rules to the transaction data, wherein an offer is presented to the user via a user interface device for acceptance or rejection, the offer comprising the installment payment plan and the dynamic incentive customized for the user.

At least a portion of the functionality of the various elements in FIG. 1, FIG. 2, FIG. 3, and FIG. 17 can be performed by other elements in FIG. 1, FIG. 2, FIG. 3 and FIG. 17, or an entity (e.g., processor 206, web service, server, application program, computing device, etc.) not shown in FIG. 1, FIG. 2, FIG. 3, and FIG. 17.

In some examples, the operations illustrated in FIG. 4, FIG. 5, FIG. 6, FIG. 7, FIG. 8, FIG. 9, FIG. 10, FIG. 11, FIG. 12, FIG. 13, and FIG. 14 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium has instructions recorded thereon which when executed by a computer device cause the computer device to cooperate in performing a method of generating dynamic incentives for instalment plan payments, the method comprising receiving a request for an installment payment plan incentive customized for a user in real-time from a requester via a network, the request associated with a transaction to purchase an item or service from a merchant: applying a set of user-configured rules to transaction data associated with the user and the transaction, the set of user-configured rules comprising a set of user-configured incentives criteria associated with the merchant or a lender: generating a dynamic incentive associated with the installment payment plan based on application of the set of user-configured rules to the transaction data, the dynamic incentive customized to the user; and transmitting the dynamic incentive to the requester, wherein the requester provides an offer to the user via a user interface device for acceptance or rejection, the offer comprising the installment payment plan and the dynamic incentive customized for the user in real-time during the transaction.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic installment payment plan incentives, the system comprising:
at least one processor; and
at least one memory comprising computer-readable instructions, the at least one processor, the at least one memory and the computer-readable instructions configured to cause the at least one processor to:
receive a request for a dynamic incentive associated with an installment payment plan customized for a user during a transaction:
apply a set of user-configurable rules to transaction data associated with the user and the transaction, the set of user-configurable rules comprising criteria for generating the dynamic incentive;
generate the dynamic incentive associated with the installment payment plan based on application of the set of user-configured rules to the transaction data; and
present an offer to the user via a user interface device, the offer comprising the installment payment plan and the generated dynamic incentive customized for the user in real-time during the transaction.

2. The system of claim 1, wherein the criteria further comprises a merchant preference associated with a type of incentive offered to the user and a value of the incentive offered to the user, wherein the generated dynamic incentive conforms to the merchant preference.

3. The system of claim 1, wherein the transaction data further comprises dynamic market trends data describing a current event or a seasonal occurrence, and wherein the generated dynamic incentive is associated with the current event or the seasonal occurrence.

4. The system of claim 1, wherein the transaction data further comprises payment card category, wherein the generated dynamic incentive is associated with a set of pre-approved types of incentive associated with the payment card category.

5. The system of claim 1, wherein the transaction data further comprises transaction history data describing an item previously purchased by the user or a service previously purchased by the user, wherein the generated dynamic incentive is associated with a credit or discount for the item or the service.

6. The system of claim 1, wherein the computer-readable instructions further cause the at least one processor to:
generate a plurality of dynamic incentives customized for the user:
calculate a score for each dynamic incentive in the plurality of dynamic incentives customized for the user, wherein each score indicates a predicted level of desirability of each incentive in the plurality of dynamic incentives to the user; and
select the dynamic incentive from the plurality of dynamic incentives having a highest score, wherein the selected dynamic incentive is recommended for pairing with the installment payment plan offered to the user.

7. The system of claim 1, wherein the computer-readable instructions further cause the at least one processor to:
update, by a machine learning component, at least one rule in the set of user-configured rules to improve an acceptance rate associated with the installment payment plan.

8. A method for dynamic installment payment plan incentives, the method comprising:
receiving a request for an installment payment plan incentive customized for a user in real-time from a requester via a network, the request associated with a transaction to purchase an item or service from a merchant:
applying a set of user-configured rules to transaction data associated with the user and the transaction, the set of user-configured rules comprising a set of user-configured incentives criteria associated with the merchant or a lender:
generating dynamic incentives associated with the installment payment plan based on application of the set of user-configured rules to the transaction data, the dynamic incentives customized to the user:
calculating a score for each of the dynamic incentives, the score associated with each dynamic incentive indicating a priority associated with that dynamic incentive;
selecting a dynamic incentive associated with a highest score for presentation to the user; and
transmitting the selected dynamic incentive to the requester, wherein the requester provides an offer to the user via a user interface device for acceptance or rejection, the offer comprising the installment payment plan and the dynamic incentive customized for the user in real-time during the transaction.

9. The method of claim 8, further comprising:
wherein each score indicates a predicted level of desirability of each incentive in the plurality of dynamic incentives to the user; and
selecting a dynamic incentive from the plurality of dynamic incentives having a highest score,
wherein the selected dynamic incentive is recommended for pairing with the installment payment plan offered to the user.

10. The method of claim 8, further comprising:
updating, by a machine learning component, at least one rule in the set of user-configured rules to improve an acceptance rate associated with the installment payment plan.

11. The method of claim 8, further comprising:
executing an incentives manager associated with a cloud server, by an application programming interface (API) to generate a plurality of dynamic incentives corresponding to a plurality of payment plan options customized for the user, the plurality of payment plan options comprising a first installment payment plan and a second installment payment plan available from the merchant or the lender; and
presenting an offer to the user via a user interface, wherein the offer comprises the first installment payment plan paired with a first dynamic incentive and the second installment payment plan paired with a second dynamic incentive.

12. The method of claim 8, further comprising:
analyzing user-specific data associated with the user and the transaction data associated with the user and the transaction;
generating an eligibility score based on a result of analysis of the user-specific data and the transaction data:
providing an installment payment plan to the user with a default incentive in response to the eligibility score below a threshold, the eligibility score below the threshold indicating the user is ineligible; and
providing the installment payment plan to the user with a dynamic incentive customized to the user in response to the eligibility score indicating the user is eligible for dynamic incentives.

13. The method of claim 8, further comprising:
selecting the dynamic incentive based on a set of preferences, the set of preferences comprising at least one of a set of merchant preferences, a set of lender preferences, a set of issuer preferences, or a set of user preferences.

14. The method of claim 8, further comprising:
prompting a user to opt-in to a dynamic incentives service via a user device; and
onboarding the user into the dynamic incentives service in response to the user selecting an option to opt-in, wherein the dynamic incentives are generated by the dynamic incentives service for the user.

15. A computer storage medium having computer-executable instructions that, upon execution by a processor of a computer, cause the processor to at least:
obtain a request for a dynamic incentive for an installment payment plan customized for a user in real-time during a transaction, the request including payment card data associated with a payment card presented by the user;
analyze transaction data associated with the transaction using a set of user-configured rules, the set of user-configured rules comprising at least one of a merchant preference or at least one payment card category criteria associated with the payment card presented by the user, the transaction data comprising at least one of dynamic market trends data or user transaction history data; and
generate a dynamic incentive associated with the installment payment plan based on application of the set of user-configured rules to the transaction data, wherein an offer is presented to the user via a user interface device for acceptance or rejection, the offer comprising the installment payment plan and the dynamic incentive customized for the user.

16. The computer storage medium of claim 15, wherein the computer-executable instructions, when executed by a processor of the computer, cause the computer to:
generate a plurality of dynamic incentives customized for the user:
calculate a score for each dynamic incentive in the plurality of dynamic incentives customized for the user, wherein each score indicates a predicted level of desirability of each incentive in the plurality of dynamic incentives to the user; and
select the dynamic incentive from the plurality of dynamic incentives having a highest score, wherein the selected dynamic incentive is recommended for pairing with the installment payment plan offered to the user.

17. The computer storage medium of claim 15, wherein the computer-executable instructions, when executed by a processor of the computer, cause the computer to further perform:
generate a first dynamic incentive associated with a first installment payment plan customized for the user:
generate a second dynamic incentive associated with a second installment payment plan customized for the user; and
present the offer to the user via the user interface device, wherein the offer comprises the first dynamic incentive paired with the first installment payment plan and the second dynamic incentive paired with the second installment payment plan.

18. The computer storage medium of claim 15, wherein the computer-executable instructions, when executed by a processor of the computer, cause the computer to further perform:
analyze user-specific data associated with the user and the transaction data associated with the transaction:
generate an eligibility score based on a result of analysis of the user-specific data and the transaction data:
provide an installment payment plan to the user with a default incentive in response to the eligibility score below a threshold, the eligibility score below the threshold indicating the user is ineligible; and
provide the installment payment plan to the user with a dynamic incentive customized to the user in response to the eligibility score indicating the user is eligible for dynamic incentives.

19. The computer storage medium of claim 15, wherein the computer-executable instructions, when executed by a processor of the computer, cause the computer to further perform:
provide an installment payment plan offer in an absence of an incentive in response to a total transaction amount of the transaction falling below a minimum threshold amount; and
provide the installment payment plan offer with the dynamic incentive in response to the total transaction amount of the transaction exceeding the minimum threshold amount.

20. The computer storage medium of claim 15, wherein the computer-executable instructions, when executed by a processor of the computer, cause the computer to further perform:
generate a first dynamic incentive for the installment payment plan to a first user; and
generate a second dynamic incentive for the installment payment plan to a second user, wherein the first dynamic incentive is a different incentive than the second dynamic incentive, and wherein the first dynamic incentive is customized to the first user based on user-specific data associated with the first user, and wherein the second dynamic incentive is customized to the second user based on user-specific data associated with the second user.
